(19) United States
(12) Patent Application Publication
(10) Pub. No.: US 2010/0222460 A1
(43) Pub. Date: Sep. 2, 2010

(54) CELLULOSE/RESIN COMPOSITE AND PROCESS FOR PRODUCING SAME

(76) Inventor: Fusao HOJO, Tokai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/707,986

(22) Filed: Feb. 18, 2010

(30) Foreign Application Priority Data
Feb. 27, 2009 (JP) 2009-045044

(51) Int. Cl. C08L 1/00

(52) U.S. Cl. 524/35

(57) ABSTRACT

The present invention provides a cellulose/resin composite wherein cellulose is uniformly dispersed in the resin and a process for producing the same. The cellulose/resin composite includes crystalline cellulose formed by reprecipitating cellulose in a polar solvent by using an ionic liquid containing cellulose dissolved therein, wherein a sum of fractions of a cellulose I type crystal component, a cellulose II type crystal component, and a non-crystalline cellulose component in the crystalline cellulose is 1, a fraction of the cellulose I type crystal component is 0.4 or more, and a fraction of the cellulose II type crystal component is 0.1 or more.

### BACKGROUND OF THE INVENTION

The present invention relates to a cellulose/resin composite and a process for producing the same.

To create a sustainable society, transformation of the traditional society of mass production, mass consumption, and mass disposal into a recycling-oriented one is strongly desired. Especially, it is necessary to replace exhaustible resources such as petroleum, which have conventionally been used as materials to produce industrial goods, with biomass resources. Under these circumstances, effective utilization of cellulose, which is the main component of wood materials, is desired. Thus, compounding cellulose into a material, which has heretofore been formed from a resin derived from petroleum, is being practiced. Above all, by compounding cellulose having I type crystal structure with a resin, lower thermal expansion and increased strength of the resin are being attained.

Cellulose comprising an I type crystal structure has been used as paper, a wood material, and a clothing material. However, because most of natural cellulose has a fibrous structure, it has been difficult to disperse it uniformly into a resin in an arbitrary form.

There are known fiber-reinforced resins having characteristics improved from the intrinsic one by compounding other compounds into the resin, namely, a nanofiber sheet and the like, which can be formed by impregnating non-woven fabric comprising microfibrillated cellulose with a resin. Also, there is known a process for forming a fiber-reinforced composite material by impregnating an aggregate comprising bacterial cellulose with a resin (see Appl. Phys. A 2005, A80, 155 and Appl. Phys. Lett. 2005, 87, 243110). In both publicly known examples, a composite material with a resin is formed by impregnating a fiber aggregate comprising cellulose having cellulose I type crystal with a resin. In this process, because the composite material is formed by impregnating the fiber with a resin, it is difficult to mold or fabricate a material of a complicated form, a thick material, or a thermoplastic resin and the like having high melt viscosity.

### SUMMARY OF THE INVENTION

It is an object of the present invention to provide a cellulose/resin composite wherein cellulose is uniformly dispersed in the resin and a process for producing the same.

That is, the cellulose/resin composite of the present invention comprises crystalline cellulose formed by reprecipitating cellulose in a polar solvent by using an ionic liquid containing cellulose dissolved therein, wherein a sum of fractions of a cellulose I type crystal component, a cellulose II type crystal component, and a non-crystalline cellulose component in the crystalline cellulose is 1, a fraction of the cellulose I type crystal component is 0.4 or more, and a fraction of the cellulose II type cellulose component is 0.1 or more.

In addition, the process for producing the cellulose/resin composite comprises the steps of dissolving cellulose in an ionic liquid; reprecipitating cellulose by adding the ionic liquid containing cellulose dissolved therein to a polar solvent containing resin micro-particles dispersed therein; forming cellulose/resin mixed powder by filtering the solution in which the resin micro-particles are dispersed and cellulose has been reprecipitated, followed by washing; and forming the cellulose/resin composite by melting the resin by heating and pressing the cellulose/resin mixed powder.

According to the present invention, cellulose can be dispersed uniformly in a resin.

Other objects, features and advantages of the invention will become apparent from the following description of the embodiments of the invention taken in conjunction with the accompanying drawings.

### DETAILED DESCRIPTION OF THE INVENTION

Hereinafter, the present invention will be described in detail.

The present invention includes mixing cellulose with resin micro-particles, when reprecipitating cellulose solubilized in an ionic liquid, and, by heating the resin, obtaining a cellulose/resin composite wherein cellulose is uniformly dispersed in the resin.

Specifically, the cellulose/resin composite can be formed through the following steps, (1) to (3):

(1) a step of obtaining a dispersion of cellulose and resin micro-particles by dispersing the resin micro-particles in an ionic liquid containing cellulose dissolved therein and adding dropwise the ionic liquid in an alcohol or water, or a step of obtaining a dispersion of cellulose and resin micro-particles by adding dropwise an ionic liquid containing cellulose dissolved therein to an alcohol or water containing the resin micro-particles dispersed therein; (2) a step of obtaining mixed powder of cellulose and the resin micro-particles by filtering the dispersion of cellulose and the resin micro-particles, followed by drying; and (3) obtaining a composite of the resin and cellulose by melting the resin micro-particles by heating and pressing the cellulose/resin mixed powder.

Cellulose which can be used in the present invention may be any as long as it can be dissolved in an ionic liquid. Examples include cellulose separated from plant fiber such as wood, cotton, and sea weed; cellulose separated from animal fiber such as a cyst of sea squirt; and bacterial cellulose. Among these, cellulose separated from plants is preferable. There may be used wood powder and the like, which are obtained by crushing pulp, cotton, and wood into powder and removing lignin and the like therefrom. In addition, these cellulose materials may be used individually or as a mixture of two or more kinds.

The resin micro-particles which can be used in the present invention are not particularly limited as long as they are thermoplastic resins. For example, there may be used thermoplastic resins such as polyethylene; polypropylene; polystyrene; vinyl chloride resin; polyethylene terephthalate; vinyl acetate resins; ABS resin; acrylic resin; fluororesin; polyamide resins; polyurethane; acetal resin; polycarbonate; cellulose plastic; polylactic acid; polyglycolic acid; polyglutamic acid; polylysine; polyvinyl alcohol; polyethers such as polyethylene glycol; polyesters such as poly-3-hydroxybutyrate, poly-4-hydroxybutyrate, polyhydroxyvalerate, polyethylene adipate, polycaprolactone, and polypropiolactone. The average particle diameter of the resin micro-particles is preferably 1 mm or less. If the diameter is more than 1 mm, agglomeration of cellulose occurs when the resin is melted and compounded with cellulose.

In the composite material of cellulose and a resin provided by the present invention, a weight fraction of cellulose fiber is preferably less than 60 wt %. If the weight fraction of cellulose fiber is 60% by weight or more, problems in moldability may arise, such as increase in melt viscosity.

It is known that cellulose is soluble in ionic liquids and that, by adding cellulose solubilized in an ionic liquid to polar solvents such as alcohol and water which can dissolve the ionic liquid, the ionic liquid is dissolved in the polar solvent and, at the same time, cellulose which is insoluble in liquids such as alcohol and water reprecipitates (US2003/0157351; J. Am. Chem. Soc. 2002. 124, 4974-4975, Macromolecules 2005, 38, 8272-8277).

The polar solvent which can be used is not particularly limited as long as it is a solvent in which the cellulose component is insoluble and which can dissolve the ionic solvent. For example, there may be used water; alcohols such as methanol and ethanol; acetonitrile; ethers such as furan and dioxane; and ketones such as acetone. In addition, these may be used in combination of two or more kinds. Preferable are alcohols such as ethanol and methanol.

The cellulose dissolved in an ionic liquid can be separated by mixing with a polar solvent. As for the cellulose obtained, one in an arbitrary form of a tube, a fiber, a particle, or the like can be obtained depending on the treatment provided at the time of mixing.

A mixed powder of cellulose and resin where the resin micro-particles are uniformly dispersed in cellulose can be obtained by, when cellulose dissolved in an ionic liquid is reprecipitated in a polar solvent, reprecipitating cellulose with resin micro-particles dispersed in the solvent and by filtering, purifying, and drying while mixing the precipitated cellulose and resin micro-particles uniformly. By melting the resin micro-particles by heating the mixed powder of cellulose and resin obtained to the melting point of the resin micro-particles or higher, and by pressing the melt, there can be obtained a composite material of cellulose and the resin, wherein cellulose is uniformly dispersed in the resin.

The ionic liquid used in the present invention is a salt or a mixture of salts, which maintains a liquid state even at room temperature and melts mainly at room temperature or lower. This type of salt or a mixture of salts is a compound comprising a cation and an anion. As the cation, organic cations may be used individually or as a mixture of two or more kinds, the organic cations including cyclic amidinium ions such as an imidazolium ion; a pyridinium ion; an ammonium ion; a sulfonium ion; and a phosphonium ion. As the anion, a halide ion, NO₂⁻, NO₃⁻, SO₄⁻, SbF₆⁻, AsF₆⁻, AlCl₄⁻, Al₂Cl₇⁻, NO₃⁻, BF₄⁻, PF₆⁻, CH₃COO⁻, CF₃COO⁻, CF₃SO₃⁻, (CF₃SO₂)₂N⁻, (CF₃SO₂)₃C⁻, and the like may be used individually or as a mixture of two or more kinds.

The cellulose used in the mixture and composite material of the present invention refers to one where a sum of fractions of a cellulose I type crystal component, a cellulose II type crystal component, and a non-crystalline cellulose component is 1, a fraction of the cellulose I type crystal component is 0.4 or more, and a fraction of the cellulose II type crystal component is 0.1 or more. In case cellulose is separated by mixing cellulose dissolved in an ionic liquid with a polar solvent, when cellulose was kept dissolved in an ionic liquid for a long time before separating cellulose by mixing the liquid with a polar solvent, crystallinity of the cellulose obtained becomes worse and a non-crystalline component increases. Thus, when a composite of the cellulose with a resin is formed, the linear coefficient of expansion of the resultant composite cannot be lowered sufficiently.

The crystal fractions of cellulose I type crystal and II type crystal in the present invention refer to the values obtained from each crystal peak in the wide-angle X-ray diffraction pattern obtained by crushing the dried cellulose sample into powder and molding it into a tablet and subjecting the tablet to a reflection method using Cu—Kα as the X-ray source. That is, the crystal fraction (X_{I}) of cellulose I type crystal is a value obtained according to equation (1) from an absolute peak intensity h₀ at 2θ=15.0°, which is the (110) surface peak of the cellulose I type crystal, and a peak intensity h₁ from a baseline at this surface separation. Similarly, the crystal fraction (X_{II}) of cellulose II type crystal is a value obtained according to equation (2) from an absolute peak intensity h₀* at 2θ=12.6°, which is the (110) surface peak of the cellulose II type crystal, and a peak intensity h₁* from a baseline at this surface separation.

X_{I}=h₁/h₀ (1)

X_{II}=h₁*/h₀* (2)

The so-called regenerated cellulose obtained by the viscose process (C. F. Cross, E. T. Bevan, and C. Beadle, Ber., 26, 1090-1097 (1893).), the cuprammonium process, the organic solvent process (C. F. Cross, E. T. Bevan, and C. Beadle, Ber., 26, 1090-1097 (1893).), and the like comprises mostly the cellulose II type crystal component and is different from the cellulose of the present invention, wherein the sum of fractions of a cellulose I type crystal component, a cellulose II type crystal component, and a non-crystalline cellulose component is 1, the fraction of the cellulose I type crystal component is 0.4 or more, and the fraction of the cellulose II type crystal component is 0.1 or more.

### DESCRIPTION OF PREFERRED EMBODIMENTS

Hereinafter, Examples of the present invention will be described.

### Example 1

Wet CELISH KY-100G manufactured by Daicel Chemical Industries, Ltd. was dehydrated and dried. An ionic liquid (1-butyl-3-methylimidazolium chloride) was warmed in an oil bath to 100° C. and melted. To the melted ionic liquid kept at 100° C. was added the dried CELISH KY-100G in an amount of 10 wt %. By stirring for 3 hours by a magnetic stirrer, CELISH KY-100G was dissolved in the ionic liquid. While stirring the obtained cellulose-ionic liquid solution by a magnetic stirrer, the solution was added dropwise to ethanol in which was dispersed resin micro-particles (high-strength polyethylene) of HDPE (trade name Sunfine, manufactured by Asahi Kasei Chemicals Corp.) of an average particle diameter of 110 μm, the solution being added in such an amount that the reprecipitated cellulose would become 30 wt % of the cellulose/resin mixed powder. After the dropwise addition, the mixture was stirred for 5 minutes by an ultrasonic homogenizer (trade name VC-130, manufactured by SONIC and MATERIALS, Inc.) to reprecipitate cellulose in ethanol. Thereafter, filtration and washing with ethanol were carried out to obtain cellulose/resin mixed powder. When crystallinity of cellulose in the cellulose/resin mixed powder was measured, the fraction of the cellulose I type crystal component was 0.5 and that of the cellulose II type crystal component was 0.3.

By hot-pressing the obtained cellulose/resin mixed powder under vacuum at 200° C., there was obtained a 0.3 mm thick cellulose/resin composite film containing cellulose in an amount of 30 wt %. When the obtained composite film of cellulose and resin was measured for a linear coefficient of expansion by a thermomechanical testing machine (trade name TM 9300, manufactured by Sinkuu Rikou Co., Ltd.), a value of 0.8×10⁻⁵ (1/K) was obtained (test specimen: 25×3 (mm), range of measurement: 25° C. to 110° C.). This was a linear coefficient of expansion smaller than that of a composite formed by mixing cellulose and the resin micro-particles (Comparative Example 3).

By increasing the amount of the cellulose/resin mixed powder when forming the composite film, a 2 mm thick composite sheet of cellulose and resin was obtained. The obtained composite sheet of the resin and cellulose was cut and fabricated in a form of pellet, and thereafter, the pellets obtained were molded by an injection molding machine at a cylinder temperature of 205° C. and a mold temperature of 80° C. to obtain molded pieces for the bending strength test. The bending strength test was carried out according to the three-point bending test method of JIS K-7171. The bending strength of the composite obtained was found to be 70 MPa. This was a strength higher than that of a composite formed by mixing cellulose and the resin micro-particles (Comparative Example 3).

### Example 2

Using polypropylene micro-particles of an average particle diameter of 105 μm (trade name SunAllomer PM900A, manufactured by SunAllomer Ltd.) as the resin micro-particles, a composite film and sheet of a resin and cellulose containing cellulose in an amount of 30 wt % were obtained by the same process as in Example 1. The linear coefficient of expansion of the film obtained was 3.2×10⁻⁵ (1/K) (test specimen: 25×3 (mm), range of measurement: −40° C. to 110° C.)

The composite sheet of a resin and cellulose obtained was molded in the same manner as in Example 1 to obtain molded pieces for the bending strength test. The bending strength of the composite obtained was 120 MPa.

In addition, the pellets obtained were molded by an injection molding machine at a cylinder temperature of 205° C. and a mold temperature of 80° C. to obtain a molded article which could be used as a housing for a motor.

### Comparative Example 1

Using (high-strength polyethylene) HDPE (trade name Sunfine, manufactured by Asahi Kasei Chemicals Corp.) as the resin micro-particles, resin film and sheet were obtained by the same process as in Example 1 without addition of cellulose. The linear coefficient of expansion of the film obtained was 2.8×10⁻⁵ (1/K). Also, the composite sheet of the resin and cellulose obtained was molded in the same manner as in Example 1 to obtain molded pieces for the bending strength test. The bending strength of the molded pieces obtained was 20 MPa.

### Comparative Example 2

Using polypropylene as the resin micro-particles, resin film and sheet were obtained by the same process as in Example 1 without addition of cellulose. The linear coefficient of expansion of the film obtained was 10.2×10⁻⁵ (1/K). Also, the composite sheet of the resin and cellulose obtained was molded in the same manner as in Example 1 to obtain molded pieces for the bending strength test. The bending strength of the molded pieces obtained was 50 MPa.

### Comparative Example 3

While stirring wet CELISH KY-100G manufactured by Daicel Chemical Industries, Ltd. by a magnetic stirrer, there was dispersed resin micro-particles (high-strength polyethylene) of an average particle diameter of 110 μm in an amount such that the content of cellulose became 30 wt %. The mixture was stirred for 5 minutes by an ultrasonic homogenizer. Thereafter, filtration and washing with ethanol were carried out to obtain cellulose/resin mixed powder. When crystallinity of the cellulose in the cellulose/resin mixed powder was measured, the fraction of the cellulose I type crystal component was 0.7 and that of the cellulose II type crystal component was 0.1.

By hot-pressing the obtained cellulose/resin mixed powder under vacuum at 200° C., there were obtained a composite film and sheet containing cellulose in an amount of 30 wt %. The linear coefficient of expansion of the film obtained was 1.4×10⁻⁵ (1/K). The composite sheet obtained was molded in the same manner as in Example 1 to obtain molded pieces for the bending strength test. The bending strength of the composite obtained was 50 MPa.

### Comparative Example 4

Using resin micro-particles (polypropylene) of an average particle diameter of 105 μm, a composite film and sheet containing cellulose in an amount of 30 wt % were obtained by the same process as in Comparative Example 3. The linear coefficient of expansion of the film obtained was 4.8×10⁻⁵ (1/K). The composite sheet obtained was molded in the same manner as in Example 1 to obtain molded pieces for the bending strength test. The bending strength of the composite obtained was 80 MPa.

It should be further understood by those skilled in the art that although the foregoing description has been made on embodiments of the invention, the invention is not limited thereto and various changes and modifications may be made without departing from the spirit of the invention and the scope of the appended claims.

1. A cellulose/resin composite comprising crystalline cellulose formed by reprecipitating cellulose in a polar solvent by using an ionic liquid containing cellulose dissolved therein, wherein a sum of fractions of a cellulose I type crystal component, a cellulose II type crystal component, and a non-crystalline cellulose component in the crystalline cellulose is 1, a fraction of the cellulose I type crystal component is 0.4 or more, and a fraction of the cellulose II type crystal component is 0.1 or more.

2. The cellulose/resin composite according to claim 1, wherein the cellulose/resin composite is a film.

3. A housing for a motor using the cellulose/resin composite according to claim 1.

4. A process for producing a cellulose/resin composite, comprising the steps of
dissolving cellulose in an ionic liquid;
reprecipitating cellulose by adding the ionic liquid containing cellulose dissolved therein to a polar solvent containing resin micro-particles dispersed therein;
forming cellulose/resin mixed powder by filtering the solution in which the resin micro-particles are dispersed and cellulose has been reprecipitated, followed by washing; and
forming the cellulose/resin composite by melting the resin by heating and pressing the cellulose/resin mixed powder.
